(19) United States
(12) Patent Application Publication
(10) Pub. No.: US 2018/0244209 A1
(43) Pub. Date: Aug. 30, 2018

(54) LIFT APPARATUS, SYSTEM AND METHOD FOR LOADING, UNLOADING AND TRANSPORTING EQUIPMENT AND CARGO

(71) Applicant: Tri-R Fabrication LLP, Libertyville, IL (US)

(72) Inventors: Rory Hebel, Volo, IL (US); Ryan Hebel, Libertyville, IL (US)

(21) Appl. No.: 15/904,636

(22) Filed: Feb. 26, 2018

Related U.S. Application Data
(60) Provisional application No. 62/463,257, filed on Feb. 24, 2017.

(51) Int. Cl. B60R 9/06

(52) U.S. Cl. CPC B60R 9/06

(57) ABSTRACT

The present disclosure relates to a lift apparatus, system and method for loading and unloading cargo and equipment from a vehicle or trailer, as well as, transporting cargo and equipment along with a vehicle or trailer. The lift apparatus is securely attached to a rear structure of a vehicle, such as the vehicle frame, wherein the apparatus is able to separately load, unload, secure and carry equipment along with the vehicle without the need to use the vehicle's cargo space. The lift apparatus and system of the present disclosure permits operation by one person to load and unload cargo and equipment from a vehicle. The lift apparatus and system can be conveniently secured in a compact closed position against the body of the vehicle when not in use.

This application claims priority to U.S. Provisional Application Ser. No. 62/463,257 filed Feb. 24, 2017, which is incorporated in its entirety herein.

### TECHNICAL FIELD

The present invention relates to a lift apparatus, system and method of transporting items, cargo and/or equipment in conjunction with a vehicle. More specifically, the present disclosure relates to a lift apparatus and method for easily loading, unloading, securing and transporting equipment and/or cargo in conjunction with a vehicle without requiring use of the vehicle's cargo space. After loading, the equipment or cargo can stay on the lift apparatus conveniently as part of the vehicle until needed. The present lift apparatus is securely mounted to the back of the vehicle, and can be conveniently and securely stowed to the vehicle. Optionally, the lift apparatus can be uninstalled and removed from the vehicle for storage or attachment to another vehicle.

### BACKGROUND

Loading and unloading equipment and cargo from the back of a truck or other vehicle can be difficult and tedious. In particular, lifting equipment onto the back of a trailer or into the cargo space of a vehicle, such as a truck, typically requires use of a forklift, crane, or potentially the brute strength of several workers. Operating a forklift however, requires a certain level of skill for balancing and lifting items onto the forks. Cranes, another equipment option for loading vehicles or trailers, are not always readily available, and likewise require special operation. Obviously, using workers to lift and remove heavy, awkward items and equipment from a truck or trailer can potentially lead to numerous issues, including damage to the items and injury to the workers.

Additionally, many vehicles, such as utility trucks, have limited storage or cargo space due to built-in bucket lifts and other equipment requirements necessary to work on repairing electrical and gas systems. Because such equipment tends to take up the majority of available cargo space, any additional space is limited, or non-existent, for carrying and storing any extraneous equipment within the bed of the truck or other vehicle.

A need, therefore, exists for improved lift apparatus, system and method for loading and unloading cargo and equipment from a vehicle or trailer. Specifically, a need exists for an improved apparatus, system and method that permits easily loading, unloading and transporting cargo or equipment separate from, and without requiring utilization of, the cargo area of a vehicle.

Moreover, a need exists for an improved lift apparatus, system and method for transporting cargo and equipment in conjunction with a vehicle, wherein the apparatus is securely attached to a back frame of the vehicle or trailer, thereby permitting portability of the apparatus without requiring use of vehicle or truck cargo space.

A need further exists for an improved lift apparatus, system and method for loading and unloading cargo and equipment from a vehicle or trailer, wherein the apparatus is powered for movement between an extended position and a retracted position, the apparatus being easily operable by one person.

A need further exists for an improved lift apparatus, system and method for loading and unloading cargo and equipment from a vehicle or trailer, wherein the apparatus is stowed on the vehicle or trailer in a compact arrangement when not in use. The compact arrangement of the apparatus also means it is conveniently transportable with the vehicle.

### SUMMARY

The present disclosure relates to an improved lift apparatus, system and method for loading and unloading cargo and equipment from a vehicle. In particular, the present disclosure relates to a lift apparatus, system and method for loading, unloading and transporting cargo and equipment in conjunction with a vehicle, such as a truck, without requiring use of the vehicle's cargo space. The lift apparatus is securely mounted to a solid structure of a vehicle, such as a rear frame hitch area, and thus the apparatus is able to separately secure and carry equipment along with the vehicle. Although the present lift apparatus is currently configured for attachment to the rear frame, it may be possible to secure the apparats to the side of a truck, if appropriate modifications to the truck are available. Operation of the present lift apparatus can be accomplished by one person, essentially through the push of a button or toggle switch, to extend and retract the apparatus for loading and unloading cargo and equipment from a vehicle. Because the lift apparatus is capable of a compact configuration, it can be conveniently secured in a closed position against the rear body or bumper of the vehicle when not in use. In this manner, the lift apparatus is easily transportable along with the vehicle.

To this end, in an embodiment of the present disclosure, a lift apparatus is provided. The lift apparatus comprises a vertical support, a movable platform secured on a lower end of the vertical support, a housing secured on an upper end of the vertical support opposite the platform; and, an operating mechanism contained within the housing for moving the vertical support and platform between a lowered position and an elevated position.

A lift apparatus configured for attachment to a vehicle, is provided. The apparatus comprises a telescopic vertical support, a mounting plate for securing the vertical support to a vehicle, a load platform pivotally attached to a bottom end of the vertical support, a housing attached to a top end of the vertical support, and, a power mechanism contained within the housing for moving the vertical support and load platform between a lowered loading/unloading position and an elevated transport position.

In another embodiment, a method of lifting and transporting equipment in conjunction with a vehicle, is provided. The method comprises the steps of attaching a lift apparatus to the vehicle, the lift apparatus comprising a telescopic, two-piece vertical support, a mounting plate for securing the vertical support to a vehicle, a load platform pivotally attached to a bottom end of the vertical support, a housing attached to a top end of the vertical support and, a power mechanism contained within the housing for moving the vertical support and load platform between a lowered position and an elevated position, activating the power mechanism for moving the vertical support and platform to a lowered, loading/unloading position at ground level; placing an item onto the load platform; activating the power mechanism for moving the load platform and item to a transport height above ground level and securing the load platform and item into position prior to moving the lift apparatus and item.

In yet another embodiment, a system for transporting an item in conjunction with a vehicle, is provided. The system comprises an item requiring transport separate from a vehicle cargo space, a lift apparatus adapted for attachment to the vehicle and configured for carrying the item, the lift apparatus comprising, a two-piece vertical support movable between an expanded position and a retracted position, a platform pivotally attached to a bottom end of the vertical support, a housing attached to a top end of the vertical support, and, a power mechanism contained within the housing for moving the vertical support and platform between a lowered position and an elevated position, wherein the platform further includes a load area configured for holding the item in position while the vertical support moves between the lowered position and the elevated position.

It is, therefore, an advantage and objective of the present disclosure to provide an improved lift apparatus and system for separately loading and unloading cargo and equipment from a vehicle.

It is another advantage and objective of the present disclosure to provide a collapsible lift apparatus that can be stowed in a secured position against the vehicle when not in use.

It is yet another advantage and objective of the present disclosure to provide an improved lift apparatus and method for transporting cargo and equipment wherein the lift apparatus is secured to a vehicle separate from the standard cargo space of the vehicle.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates an embodiment of a lift apparatus of the present disclosure in a stowed position on a utility vehicle;

FIG. 1a illustrates an embodiment of the lift apparatus of the present disclosure in the initial horizontal position;

FIG. 2 illustrates the lift apparatus of the present disclosure in the extended, loading/unloading position;

FIG. 3 illustrates the lift apparatus of the present disclosure with an exploded view of the housing;

FIG. 3a illustrates a close-up of the toggle switch for operation of the lift apparatus of the present disclosure;

FIG. 4 illustrates a side rear view of the lift apparatus of the present disclosure;

FIG. 5 illustrates the lift apparatus of the present disclosure in the extended, load position for receiving an equipment cart;

FIG. 6 illustrates the lift apparatus of the present disclosure in the upward, loaded position with the equipment cart secured thereto for transport.

### DETAILED DESCRIPTION

The present disclosure relates to a lift apparatus, system and method for loading, unloading and transporting cargo and equipment. In particular, the present lift apparatus is adapted for attachment to a vehicle, such as a utility truck. In this manner, the present lift apparatus is useful transporting cargo and/or equipment without requiring use of the vehicle's cargo space. When not in use, the lift apparatus can be conveniently stowed to the vehicle, for example, secured near the bumper on the frame of the vehicle in a folded, compact configuration. The ease of use of the present lift apparatus, including the powered raising and lowering of a load platform, enables a single user to easily load and secure equipment from the ground, raise the secured equipment up to the vehicle for transport, and similarly lower and unload equipment from the vehicle to the ground.

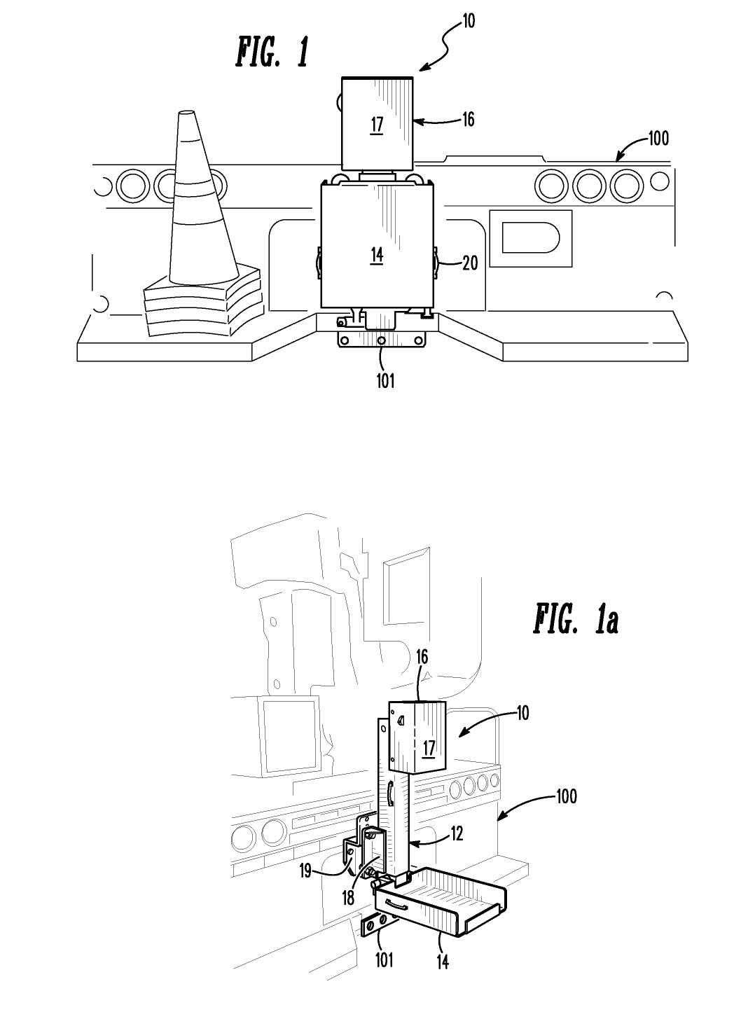

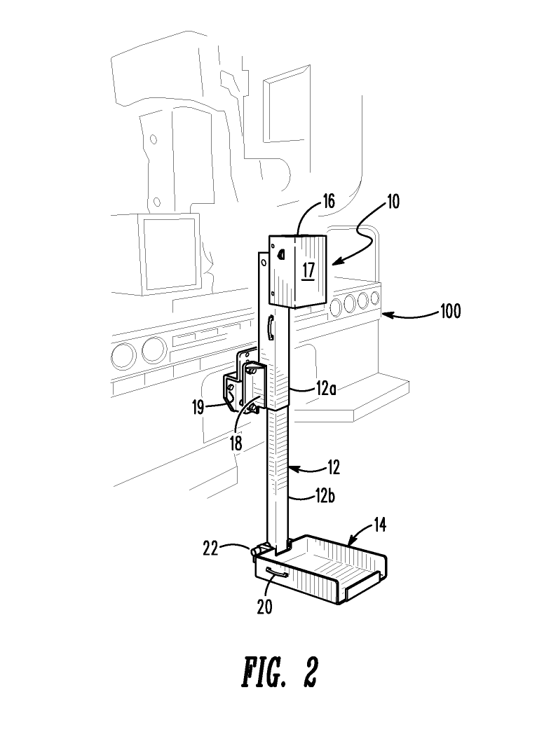

Now referring to the figures, FIGS. 1, 1a and 2 illustrate the lift apparatus 10 of the present disclosure in use on a utility truck 100. The present lift apparatus 10 is designed primarily for utilization with trucks or utility vehicles, such as utility trucks or pickup trucks, wherein the cargo bed of the truck is occupied by other necessary forms of equipment, such as lift buckets, ladders and other equipment. In these situations, it is difficult or impossible to carry any additional equipment in the cargo area. Therefore, an advantage of the present lift apparatus 10 is that it is adaptable for securing to a vehicle, separate from the cargo area, where it can be easily transported along with the vehicle.

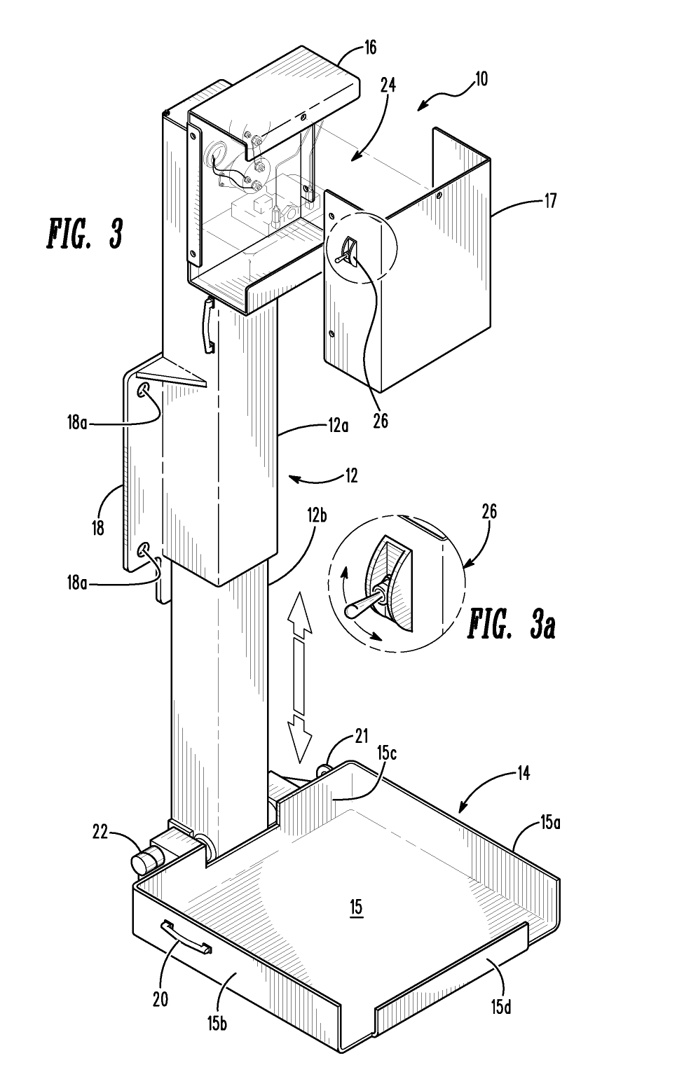

Referring now to FIGS. 1-3, there is shown an embodiment of a lift apparatus 10 of the present disclosure. Specifically, FIG. 1 illustrates the present lift apparatus 10 on in the compact, stowed position on the back of a utility truck 100; FIG. 1a illustrates the present lift apparatus 10, wherein the platform is in the initial horizontal position; FIG. 2 illustrates the present lift apparatus 10 in the extended, loading/unloading position on the back of the truck 100; and, FIG. 3 illustrates a front view of the present lift apparatus 10, with the housing cover 17 removed. The lift apparatus 10 includes a vertical support 12, a movable platform 14 secured on a lower end of the vertical support, and a housing 16 secured on an upper end of the vertical support opposite the platform. The present lift apparatus 10 provides a convenient, compact device for transporting equipment or cargo without using the cargo bed of a truck 100, or without requiring use of a separate trailer attached to the vehicle. In view of the apparatus being exposed to the elements, it is preferred that the lift apparatus 10 be constructed from any durable, corrosion resistant materials.

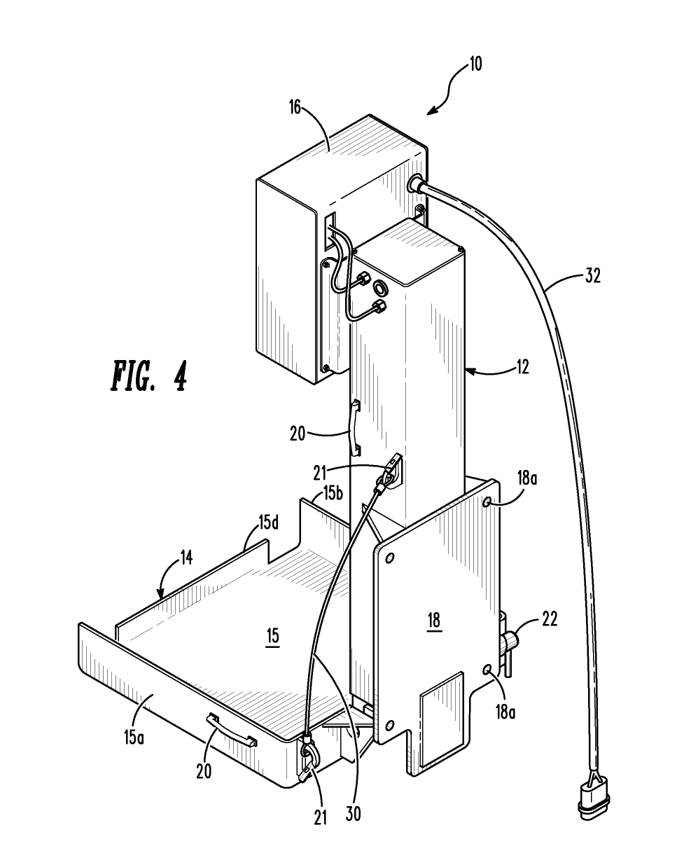

As shown in FIG. 3, the vertical support 12 generally has a square or rectangular cross-section, and forms the backbone support for the lift apparatus 10. It should be understood that although a rectangular vertical support 12 is shown, the vertical support can have any suitable shape, including a round to tubular shape. The vertical support 12 has a two-piece, telescoping construction, including a first or top section 12a and a second or bottom section 12b. A mounting plate 18 is used to secure the lift apparatus 12 to an adapter plate 19 attached to the frame of the vehicle body. As shown in FIGS. 3 and 4, the mounting plate 18 includes a plurality of openings 18a therein for receiving a suitable fastener (not shown) for securing the apparatus to the adapter plate 19 and then to the frame of the utility truck 100.

The second or bottom section 12b of the vertical support 12 is configured for telescopic engagement within the first section 12a of the vertical support. In this manner, the second section 12b is slidable within the first or top section 12a between a downward extended position and an upward retracted position. Specifically, when the lift apparatus 10 is moved into the loading/unloading position, the second section 12b of the vertical support 12 extends completely from the first section 12a and to ground level (FIG. 2). When the lift apparatus 10 is in the stored or transport position, the second section 12b is in a retracted position, and completely retracted into the first section 12a (FIG. 1). The telescopic feature of the vertical support 12 enables the lift apparatus 10 to move into a compact configuration during both transport of items on the apparatus or when in a stored, unused position. This compact arrangement is advantageous because when the lift apparatus 10 is attached to the back of a truck 100, it does not extend away from the body of the truck, as shown in FIG. 1.

As illustrated in FIGS. 1-4, a platform or load platform 14 is attached to an end of the second section 12b of the vertical support 12 using known fasteners. Specifically, the platform 14 is pivotally attached using known hinge pins container within the bottom end of the second section 12b. The hinge pins enable the platform to move between an upright vertical stowed position, and a downward horizontal use position. The platform 14 is generally any suitable shape, having a base 15 or load area enclosed on at least two sides by upright walls 15a, 15b. Preferably, a third wall 15c, is formed on the rear section of the platform. Handles 20 may be added to opposing sides 15a, 15b of the platform 14, as well as on either side of the vertical support 12. The handles 20 are useful for engaging load securing straps, such as ratchet straps 51, which are wrapped around to secure the piece of equipment 50 after it is loaded onto the platform (FIG. 6) and then secured by attachment to the handles.

The platform 14 may be open toward the front, or enclosed by a front wall 15d, which may act as a barrier for assisting in bracing equipment loaded onto the platform. Optionally, the front wall 15d may be moveable, attached using known attachments, such that the front wall pivots downward for access to the load area 15 of the platform 14, and upward into position after either loading or removing items from the platform. The front wall 15d may also include known locking/unlocking mechanisms for locking and unlocking the front wall in place.

As shown in FIG. 1, when the lift apparatus 10 is in a stored configuration, the platform 14 is in an upright position in parallel alignment with the vertical support 12. The second section 12b of the vertical support 12 is retracted within the interior of the first section 12a. Locking/unlocking mechanisms, in the form of a rotatable handle 22 is located the second section 12b, near the platform 14 (FIGS. 2 and 4). The rotatable handle 22 rotates a locking mechanism (not shown) located within the interior of the lower section 12b of the vertical support. The locking mechanism keeps the platform 14 in the desired position, whether upright in the stored position, or in the downward horizontal use position. Specifically, release of the platform 14 is accomplished through rotation of the handle 22 by 180°, which unlocks the platform allowing it to pivot from the vertical stored position (FIG. 1) to the initial horizontal position (FIG. 1a). Rotation back of the handle 22 then locks the platform 14 in the horizontal position. For stowing the platform 14, the handle 22 is again rotated back to release the platform 14 so it can be pivoted back into the vertical stowed and locked position.

Additionally, and when the platform 14 is in the upright stowed position and the second section 12b of the vertical support 12 is retracted within the interior of the first section 12a, a safety mechanism is in place to secure the apparatus 10 in position in the event of an electrical malfunction or the hydraulic line (not shown) breaks. Specifically, as shown in FIG. 4, a safety cable 30 connects to safety latches 21 on the platform 14 and the vertical support 12, respectively (FIG. 4). The safety strap 30 is unlatched prior to lowering the platform 14 from the stowed position to the horizontal position, and before lowering or extending the lower section 12b of the vertical support to the ground. Other safety mechanisms may be used in addition to or in place of the safety cable 30, including a locking pin (not shown) passing through the two sections 12a, 12b of the vertical support 12. Once the items or equipment are loaded onto the lift apparatus and secured, the safety strap 30, or other safety mechanism is latched to secure the apparatus during transport.

Movement of the vertical support 12, and specifically raising and lower the second section 12b of the vertical support 12, is accomplished through use of a hydraulic cylinder (not shown) contained inside the vertical support 12. The hydraulic cylinder is powered by a 12 volt electric powered hydraulic pump 24 contained within the housing 16. The hydraulic cylinder and pump are activated by a button or switch, such as a toggle switch 26 located on a side of the housing (FIG. 3a). As shown in FIG. 4, a power and ground cable 32 from the housing 16 attaches to a power cable (not shown), which provides power from the vehicle battery (not shown) to the hydraulic pump 24 and hydraulic cylinder. The toggle switch 26 is held by the user, upward or downward depending on the operation of the apparatus, until the desired height of the platform 14 is reached. Once the desired raised or lowered height is reached, releasing the toggle switch 26 stops operation of the pump 24 and hydraulic cylinder and movement of the vertical support 12. In this manner, control over the operation of the lift apparatus 10, and specifically the height of the platform 14 is easily monitored and controlled by the user through use of the toggle switch 26.

Mounting the present lift apparatus 10 onto the vehicle, such as the utility truck 100 is best accomplished on vehicles having a V-style bumper, without a center section. In this manner, the lift apparatus 10 can be mounted close to the vehicle body, and does not extend much further out than the width of the bumper. It may be possible to mount the lift apparatus 10 to a vehicle having a straight bumper with an appropriate modification.

Mounting the present lift apparatus 10 is generally accomplished through replacement of the standard pintle hitch with an adapter plate 19, which is secured to the frame of the vehicle. The mounting plate 18 includes a plurality of openings 18a for receiving appropriate fasteners (not shown) such as bolts, for attachment of the mounting plate to the plurality of openings in the adapter plate 19, which permit height adjustment of the mounting plate to the adapter plate. Securing the mounting plate 18 to the adapter plate 19 on the vehicle 100 may also require relocation of a backup camera view window, and any lights, such as the standard three running lights. For example, as shown in FIG. 1, at least one light bar 101 may be attached beneath the lift apparatus 10. Although attachment of the present lift apparatus 10 is shown at the back of the vehicle 100, with appropriate modifications, the lift apparatus may also be attached to the side of the vehicle. Additionally, possible future modifications of the vehicle frame, may permit securing the lift apparatus 10 directly to the frame in any location, without requiring use of the adapter plate 19.

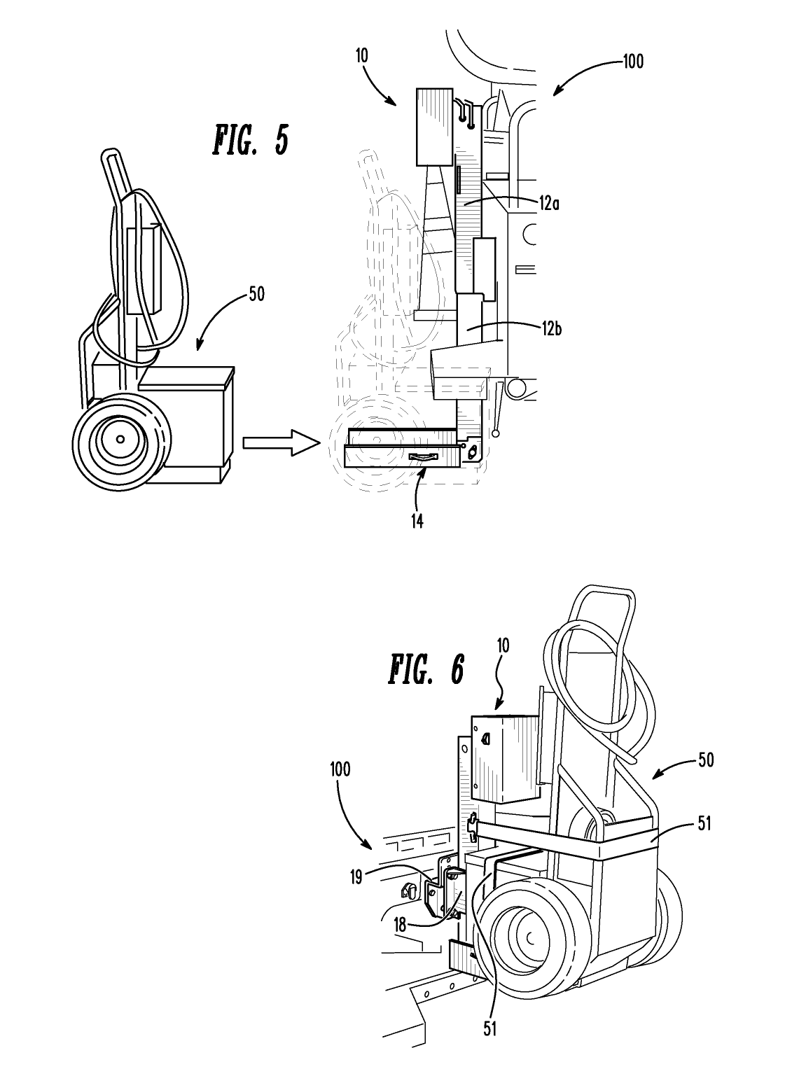

As shown in FIGS. 5 and 6, the present lift apparatus is useful as a separate transport apparatus for equipment (as shown), cargo or other items that may be require by the user. The lift apparatus 10 is particularly advantageous for those vehicles, such as a utility vehicle 100 (FIGS. 1 and 2) that has little or no cargo space for extra equipment. Use of the present lift apparatus 10 permits storage and transport of extra equipment, such as an equipment cart 50, as shown.

After the lift apparatus 10 is securely attached to the back of a vehicle 100, loading and operation of the lift apparatus is easily accomplished by a single user. Initially, when the platform 14 is in the upright stored position (FIG. 1), the lock handle 22 is pivoted around about 180° to release the platform so it can be pivoted from the upright vertical positon to the horizontal use position. The lock handle 22 is then rotated around again to lock the platform 14 in the horizontal position.

Once the platform 14 is locked in the horizontal position, it is lowered to the ground through activation of the vertical support 12 (FIG. 2). Activating the toggle switch 26 activates the 12 volt electric powered hydraulic pump assembly (24) contained within the housing 16 and the hydraulic cylinder (not shown) within the vertical support 12. Upon activation, the second section 12b of the vertical support 12 moves downward, extending from the first section 12a of the vertical support, thereby lowering the platform 14 to the ground at a sufficient point for easily loading/unloading equipment or cargo to and from the platform. However, the platform 14 should be placed at ground level for loading/unloading, but not to the point of inadvertently lifting the supporting vehicle. (FIG. 2). A pressure activated switch may be incorporated to assist in lowering the platform 14 to the appropriate ground level.

FIGS. 5 and 6 illustrate the lift apparatus 10 in use, specifically showing loading of an equipment cart 50 rolled onto the lowered platform 14. Although an equipment cart 50 is shown as an example, it should be understood that any type of equipment or cargo that can be secured properly is capable of being carried by the lift apparatus 10. After loading, the toggle switch 26 is activated by the user, and the second section 12b of the vertical support 12 retracts upward into the first section 12a, lifting the platform 14 and the equipment cart 50 to the raised position (FIG. 6). The equipment cart 50 can then be further secured to the lift apparatus 10 using conventional ratchet straps 51, which are secured around the cart, and attached to handles 20 on either side of the platform 14. In this manner, the lift apparatus 10 and stowed equipment cart 50 are conveniently transported along with the vehicle, without requiring the use of any of the vehicle's cargo space.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

1. A lift apparatus comprising:
a vertical support;
a movable platform secured on a lower end of the vertical support;
a housing secured on an upper end of the vertical support opposite the platform; and,
an operating mechanism contained within the housing for moving the vertical support and platform between a lowered position and an elevated position.

2. The lift apparatus of claim 1, wherein the vertical support further comprises a first section and a second section.

3. The lift apparatus of claim 2, wherein the second section is slidable vertically within the first section between an upward position and a downward position.

4. The lift apparatus of claim 2, wherein the platform is pivotally connected on an end of the second section of the vertical support.

5. The lift apparatus of claim 4, wherein the second section is retractable within the first section for raising the platform above ground level, and extendable from the first section for lowering the platform to ground level.

6. The lift apparatus of claim 1, wherein the second section further includes a rotatable handle for locking and releasing the platform for pivotal movement.

7. The lift apparatus of claim 6, wherein the platform is pivotally moveable between an upright stored position and a horizontal use position.

8. The lift apparatus of claim 1, wherein the vertical support further includes a mounting plate on a back surface of the first section.

9. The lift apparatus of claim 7, wherein the mounting plate secures to an adaptor plate on a frame of the vehicle.

10. (canceled)

11. (Cancelled)

12. (canceled)

13. The lift apparatus of claim 1, wherein the platform further includes a load area formed by at least two sides defining a perimeter of the load area.

14. The lift apparatus of claim 13, wherein the platform further includes a locking mechanism for securing the platform in an upright closed position.

15. A method of lifting and transporting equipment in conjunction with a vehicle, the method comprising the steps of:
attaching a lift apparatus to the vehicle, the lift apparatus comprising:
a telescopic, two-piece vertical support;
a mounting plate for securing the vertical support to an adaptor plate on a vehicle frame;
a load platform pivotally attached to a bottom end of the vertical support;
a housing attached to a top end of the vertical support; and,
a power mechanism contained within the housing for moving the vertical support and load platform between a lowered position and an elevated position;
activating the power mechanism for moving the vertical support and platform to the lowered position at ground level;
placing an item onto the load platform;
securing the load platform and item into position prior to moving the lift apparatus and item; and,
activating the power mechanism for moving the load platform and item to the elevated position above ground level.

16. The method of claim 15, wherein the method further includes the step of pivoting the platform between an upright stored position and a downward horizontal use position prior to lowering the platform to ground level and placing the item onto the load platform.

17. The method of claim 15, wherein the method further includes the step of transporting the elevated secured load platform and item in conjunction with the vehicle.

18. The method of claim 15, wherein the method further includes the step of activating the power mechanism for lowering the load platform and item to ground level for unloading the item.

19. A system for transporting an item in conjunction with a vehicle, the system comprising:
an item requiring transport separate from a vehicle cargo space;
a lift apparatus adapted for attachment to the vehicle and configured for carrying the item, the lift apparatus comprising:
a two-piece vertical support movable between an expanded position and a retracted position;
a platform pivotally attached to a bottom end of the vertical support;
a housing attached to a top end of the vertical support; and,
a power mechanism contained within the housing for moving the vertical support and platform between a lowered position and an elevated position;
wherein the platform further includes a load area configured for holding the item in position while the vertical support moves between the lowered position and the elevated position.

20. The system of claim 19, wherein the platform is configured for moving between a stored position and a use position.
